(19) United States
(12) Patent Application Publication
(10) Pub. No.: US 2019/0095531 A1
(43) Pub. Date: Mar. 28, 2019

(54) JOB FLAVOR FACETING

(71) Applicant: LinkedIn Corporation, Sunnyvale, CA (US)

(72) Inventors: Weidong Zhang, Cupertino, CA (US); Kevin Kao, San Jose, CA (US); Sang Mercado, Sunnyvale, CA (US)

(21) Appl. No.: 15/717,335

(22) Filed: Sep. 27, 2017

(51) Int. Cl. G06F 17/30; G06F 15/18; G06Q 10/10; G06Q 50/00

(52) U.S. Cl. CPC G06F 17/30867; G06Q 50/01; G06Q 10/1053; G06F 15/18

(57) ABSTRACT

In an example embodiment, a search query is received via a user interface. A member identification, in a social networking service, is then obtained for a member who generated the search query. The member identification is forwarded to a faceting service, the faceting service designed to return a list of top N organization identifications corresponding to organizations having a plurality of employees who share an attribute in common with the member. The list of top N organization identifications is received from the faceting service. The search query is augmented with the list of top N organization identifications, and the augmented search query is sent to a search platform to obtain a first set of search results corresponding to the top N organization identifications. At least a portion of the first set of search results are then displayed in the user interface.

### TECHNICAL FIELD

The present disclosure generally relates to the processing of searches performed in computer systems. More specifically, the present disclosure relates to the faceting of job search results.

### BACKGROUND

A faceted search is a type of search performed by users in a computer system. In a faceted search, dynamic filters are displayed in a user interface. These dynamic filters list different types of information (called facets) for the different results, as well as sample values corresponding to the types of information from the results. For example, if the data set being searched consists of job listings, facets may be created for types of information such as location, company, job title, pay scale, etc. For each of these facets, actual values from the data set may be presented as selectable filters. Thus, for example, for location, there may be a selectable filter allowing the user to search on all locations, another selectable filter allowing the user to limit the search to just results in the United States, another selectable filter allowing the user to limit the search to just results in the United Kingdom, and so on, with the countries displayed being countries listed as locations in actual search results from the last query (e.g., Zaire will not be listed as a selectable filter because there are no results in the last result set having a location of Zaire). Additionally, for each of these selectable filters, the corresponding count of the number of search results that have the corresponding facet(s) is provided. Providing such counts, and indeed the initial determination of whether even a single search result has the corresponding facet, can be difficult when the number of search results grows to a significant amount. A brute force approach where, at runtime, each of the potential search results is scanned for particular data indicating whether each search result has the facet does not scale well, and in fact it becomes impossible to serve real-time search results with correct facet counts when the number of potential search results in great enough. This is even more true in cases where the facet is not an easily identifiable fact, for example when it is a determination of whether a job listing pertains to a company that typically hires from a school that the searching user attended. While this type of data is available in a social networking system, it requires several steps to obtain such data for each search result (e.g., retrieve the search result, identify the company corresponding to the search result, review member profiles of members employed by the company to determine schools attended, etc.). Additionally, hiring priorities for companies are ever-changing and therefore peer lists, even when identifiable, are not static.

### DESCRIPTION OF THE DRAWINGS

Some embodiments of the technology are illustrated by way of example and not limitation in the figures of the accompanying drawings.

FIG. 1 is a block diagram illustrating a client-server system, in accordance with an example embodiment.

FIG. 2 is a block diagram showing the functional components of a social networking service, including a data processing module referred to herein as a search engine, for use in generating and providing search results for a search query, consistent with some embodiments of the present disclosure.

FIG. 3 is a block diagram illustrating the search engine of FIG. 2, in accordance with an example embodiment, in more detail.

FIG. 4 is a block diagram illustrating a school faceting service of FIG. 3, in accordance with an example embodiment, in more detail.

FIG. 5 is a block diagram illustrating an employer faceting service of FIG. 3, in accordance with an example embodiment, in more detail.

FIG. 6 is a flow diagram illustrating a method for augmenting a search query in a search engine of a computer system in accordance with an example embodiment.

FIG. 7 is a screen capture depicting job flavor faceting of job search results in accordance with an example embodiment.

FIG. 8 is a screen capture depicting filtered job search results in accordance with an example embodiment.

FIG. 9 is a block diagram illustrating an architecture of software in accordance with an example embodiment.

FIG. 10 illustrates a diagrammatic representation of a machine in the form of a computer system within which a set of instructions may be executed for causing the machine to perform any one or more of the methodologies discussed herein, according to an example embodiment.

### DETAILED DESCRIPTION

### Overview

The present disclosure describes, among other things, methods, systems, and computer program products, which individually provide functionality for efficiently calculating facets displayed as selectable filters and corresponding facet counts from search results. In this document the search results discussed will be job postings in a social networking system, although aspects of the disclosed solutions can be applied to other types of search results as well.

In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

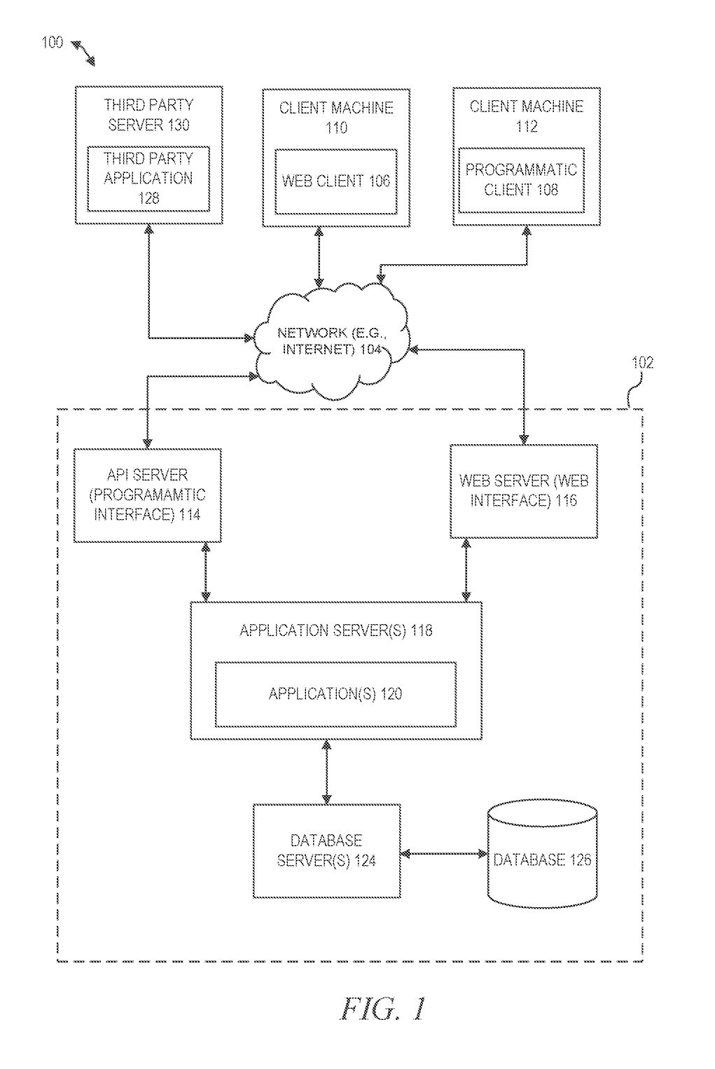

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application server(s) 118 host one or more applications 120. The application server(s) 118 are, in turn, shown to be coupled to one or more database servers 124 that facilitate access to one or more database 126. While the application(s) 120 are shown in FIG. 1 to form part of the networked system 102, it will be appreciated that, in alternative embodiments, the application(s) 120 may form part of a service that is separate and distinct from the networked system 102.

Further, while the client-server system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the application(s) 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer (PC), a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112 and third party server machine 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

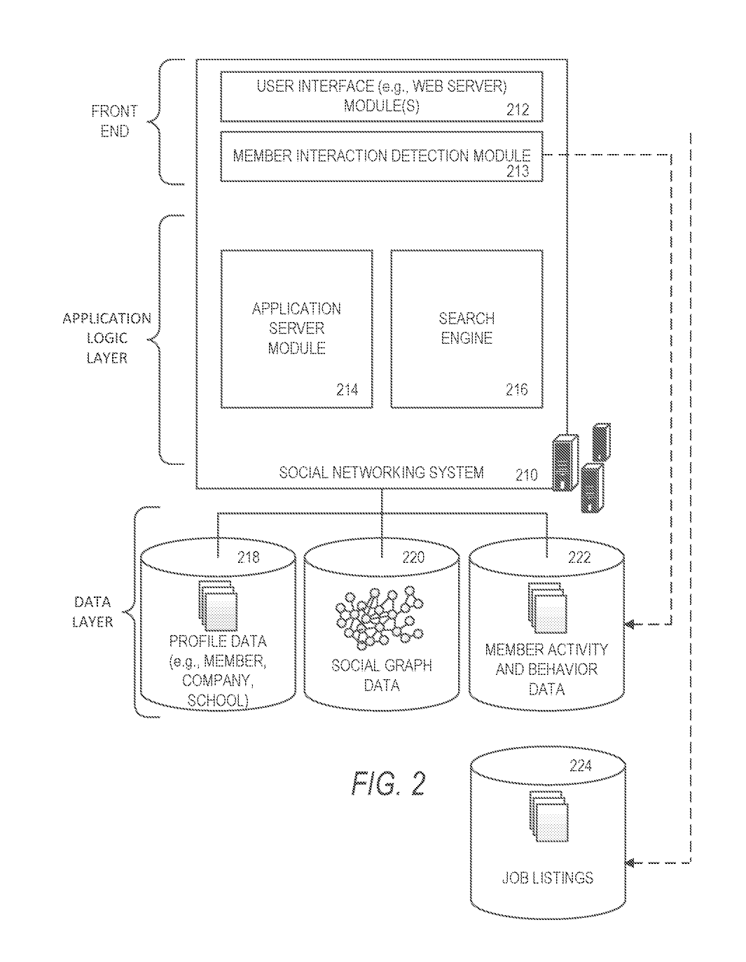

In some embodiments, the networked system 102 may comprise functional components of a social network service. FIG. 2 is a block diagram showing the functional components of a social networking service, including a data processing module referred to herein as a search engine 216, for use in generating and providing search results for a search query, consistent with some embodiments of the present disclosure. In some embodiments, the search engine 216 may reside on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices and communicates appropriate responses to the requesting client devices. For example, the user interface module(s) 212 may receive requests in the form of Hypertext Transport Protocol (HTTP) requests, or other web-based, API requests. In addition, a member interaction and detection module 213 may be provided to detect various interactions that members have with different applications, services, and content presented. As shown in FIG. 2, upon detecting a particular interaction, the member interaction and detection module 213 logs the interaction, including the type of interaction and any meta-data relating to the interaction, in the member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service.

As shown in FIG. 2, a data layer may include several databases, such as a database 218 for storing profile data, including both member profile data as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). With some embodiments, the profile data may be processed (e.g., in the background or offline) to generate various derived profile data. For example, if a member has provided information about various job titles that the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources and made part of a company's profile.

Once registered, a member may invite other members, or be invited by other members, to connect via the social networking service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph in the social graph database 220.

As members interact with the various applications, services and content made available via the social networking service, the members' interactions and behavior (e.g., content viewed, links or buttons selected, messages responded to, etc.) may be tracked and information concerning the member's activities and behavior may be logged or stored, for example, as indicated in FIG. 2, by the member activity and behavior database 222. This logged activity information may then be used by the search engine 216 to determine search results for a search query.

Additionally, a job postings database 224 may contain job postings for available positions at various companies/organizations.

In some embodiments, databases 218, 220, and 222 may be incorporated into database(s) 126 in FIG. 1. However, other configurations are also within the scope of the present disclosure.

Although not shown, with some embodiments, the social networking system 210 provides an API module via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the search engine 216 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when indexing member profiles, forward search indexes are created and stored. The search engine 216 facilitates the indexing and searching for content within the social network service, such as the indexing and searching for data or information contained in the data layer, such as profile data (stored. e.g., in database 218), social graph data (stored, e.g., in database 220), and member activity and behavior data (stored, e.g., in database 222). The search engine 216 may collect, parse, and/or store data in an index or other similar structure to facilitate the identification and retrieval of information in response to received queries for information. This may include, but is not limited to, forward search indexes, inverted indexes, N-gram indexes and so on.

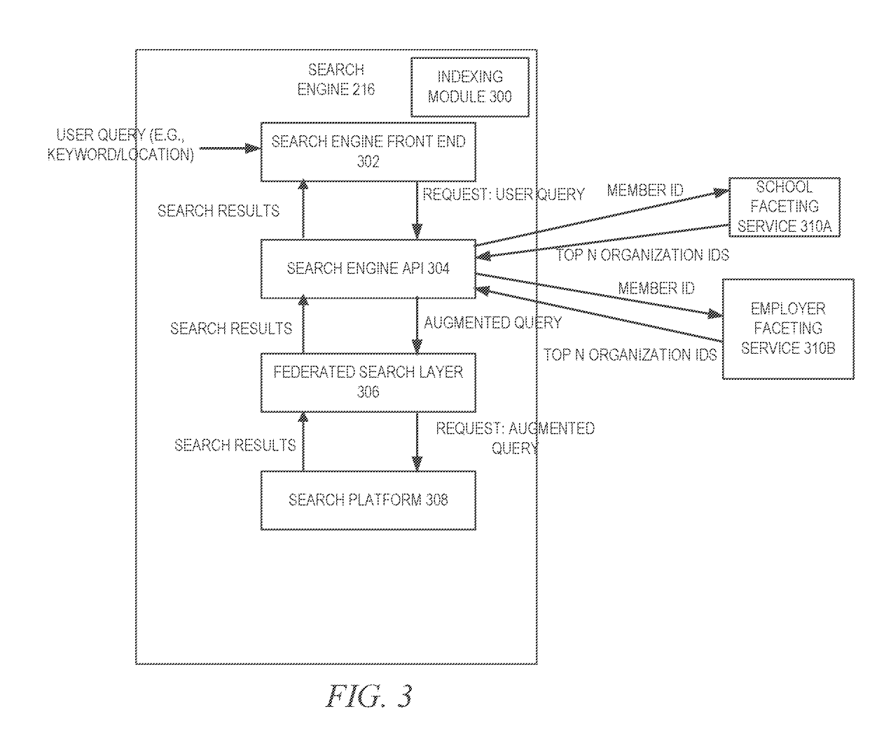

FIG. 3 is a block diagram illustrating the search engine 216, in accordance with an example embodiment, in more detail. As can be seen, the search engine 216 includes an indexing module 300. The indexing module 300 acts to index information from the social network. It should be noted that this indexing may occur either offline (e.g., performed periodically and not in response to a user query) or online (e.g., performed in real-time in response to a user query). As such, in some example embodiments, the indexing module 300 may be located outside of the search engine 216, either in lieu of or in addition to inside the search engine 216.

In some examples embodiments, a search engine front-end 302 receives user input to generate a search query. This search query may be a fill query, such as a member name or company name (e.g. “Apple”), and/or a partial query, such as a string of characters that make up a partially input query (e. g., “A-P-P”). The query could be of several different query types, including natural language queries, structure queries, and so on. Also, in some example embodiments the query may take different forms, such as informational queries, navigational queries, transactional queries, connectivity queries, and so on.

In some example embodiments, the search engine front-end 302 transmits the query via a search engine API 304 to a federated search layer 306. The federated search layer 306 is able to distribute searches to multiple searchable resource simultaneously. In an example embodiment, the federated search layer 306 interacts with a search platform 308 that performs searches on job postings.

In an example embodiment, the search engine API is redesigned to redirect a user query to one or more faceting services, including, for example, a school faceting service 310A and/or an employer faceting service 310B. Each of these services 310A-310B act to identify organization identifiers corresponding to organizations, such as companies, that have hired employees having a corresponding attribute (in the case of the school faceting service 310A the attribute is attendance of a particular school, in the case of the employer faceting service 310B, the attribute is previous employment at a particular employer). The school faceting service 310A and the employer faceting service 310B each return a listing of the top N organization IDs. How these top N are identified and selected will be described in more detail below.

The search engine API 304 then acts to augment the original search query with the top N organization IDs. For example, if the original search was for software engineer jobs in Silicon Valley and the school faceting service 310A was used to identify the top N companies that hired from the same school attended by the user who generated the query, then the search engine API 304 would augment the software engineer jobs in Silicon valley with the top N list of organization IDS, and thus the results ultimately returned by the search platform 308 would include only job listings for those top N organizations.

Once the search results are received they may be displayed to the member performing the search query. In some example embodiments, a larger set of search results (e.g., the search results of the original search query not augmented) are used to present results the member and the member is given the opportunity to filter the larger set of search results to the smaller set of search results returned by the augmented search query. This opportunity may be presented to the user in the form of a facet selection box displayed on the side of the user interface, which, if selected, causes the larger set of search results to be filtered to the smaller set. Additionally, a count of the number of search results corresponding to the facet may be displayed next to this facet selection box.

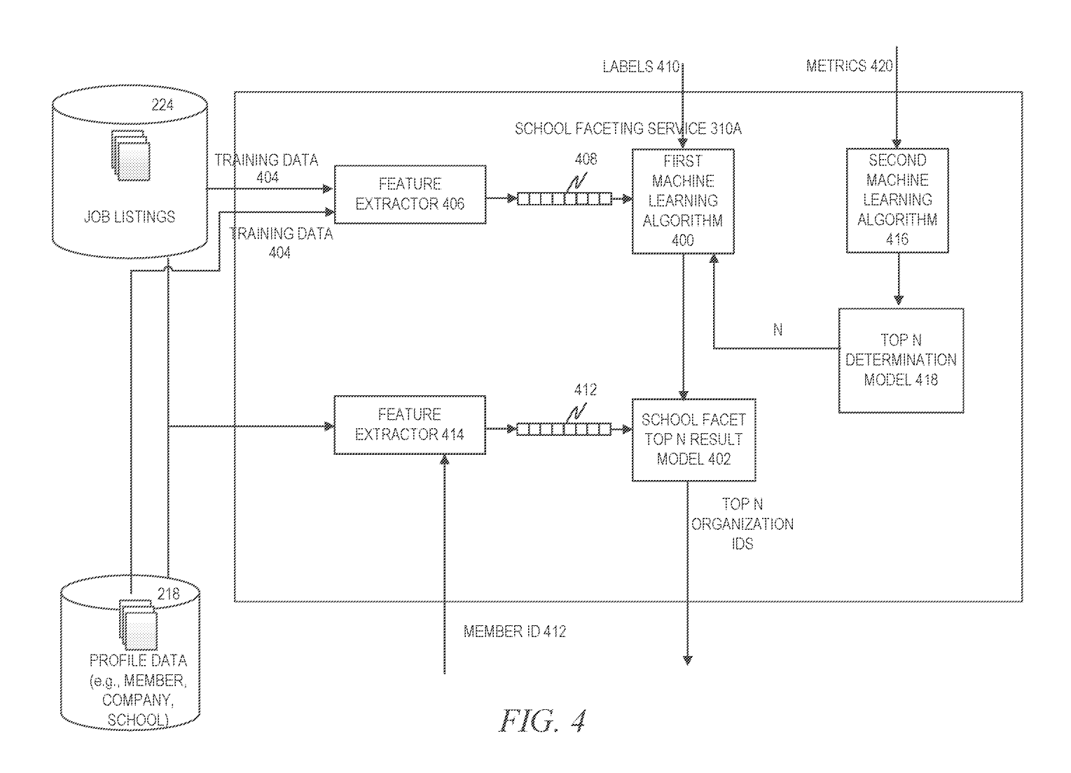

FIG. 4 is a block diagram illustrating a school faceting service 310A in more detail. Here, a first machine learning algorithm 400 may be used to train a school facet top N result model 402 to output the top N organizations having employees from a specified school. Specifically, training data 404, in the form of member profiles from profile database 218 and job listing database 224, may be fed to a feature extractor 406, which extracts one or more features 408 from the member profiles. The one or more features 408 may then be fed to the first machine learning algorithm 400 along with one or more labels 410 (in the case of a supervised machine learning algorithm).

The first machine learning algorithm 400 may be selected from among many different potential supervised or unsupervised machine learning algorithms. Examples of supervised learning algorithms include artificial neural networks, Bayesian networks, instance-based learning, support vector machines, random forests, linear classifiers, quadratic classifiers, k-nearest neighbor, decision trees, and hidden Markov models. Examples of unsupervised learning algorithms include expectation-maximization algorithms, vector quantization, and information bottleneck method. In an example embodiment, a binary logistical regression model is used. Binary logistic regression deals with situations in which the observed outcome for a dependent variable can have only two possible types. Logistic regression is used to predict the odds of one case or the other being true based on values of independent variables (predictors).

The one or more features 408 may include, but are not limited to, a count of the number of active job listings from a organization and a count of the number of active employees who graduated from the school in question and are currently employed by the organization, the size of the organization, the ratio of the size of the organization and the number of active employees who graduated from the school currently employed by the organization, etc.

Once the school facet top N result model 402 is trained, it may be used to produce results of a listing of top N organization IDs when presented with one or more features 412 extracted by a feature extractor 414 from member profiles and/or job listings and when presented with a member ID 412. In this manner, when the search engine API 304 of FIG. 3 sends a member ID, the schools attended by the corresponding member can be retrieved from a corresponding member profile and the top N organization IDs for this school can then returned to be used to augment the search query.

Additionally, in some other example embodiments, the identification of top N organizations for particular schools may be performed offline and stored for future use, so that the list for various schools may simply be accessed at runtime.

In some example embodiments, N may be a preset number (e.g., 50). In other example embodiments, a second machine learning algorithm 416 may be used to train a top N determination model 418 to determine N. Here, various metrics 420 may be used to train the top N determination model, including how fast the top N organization IDs can be obtained, the relevance of each organization ID (e.g., organizations that have only a few hires from a school may not be relevant, or they might be if the organization is small enough). The metrics 420 may also include the top N organization IDs from the school facet top N result model 402.

In some example embodiments the school facet top N result model 402 is used offline, and thus not in response to an actual query coming in, to obtain a list of top N organizations hiring from various individual schools (e.g., all accredited colleges and universities). This may be performed periodically and the list stored for future access at query-time.

Additionally, in some example embodiments, a threshold test is used prior to obtaining member profiles for members at particular organizations. For example, if the organization currently has no active job posting, then that organization can be excluded from the potential list of top N organizations.

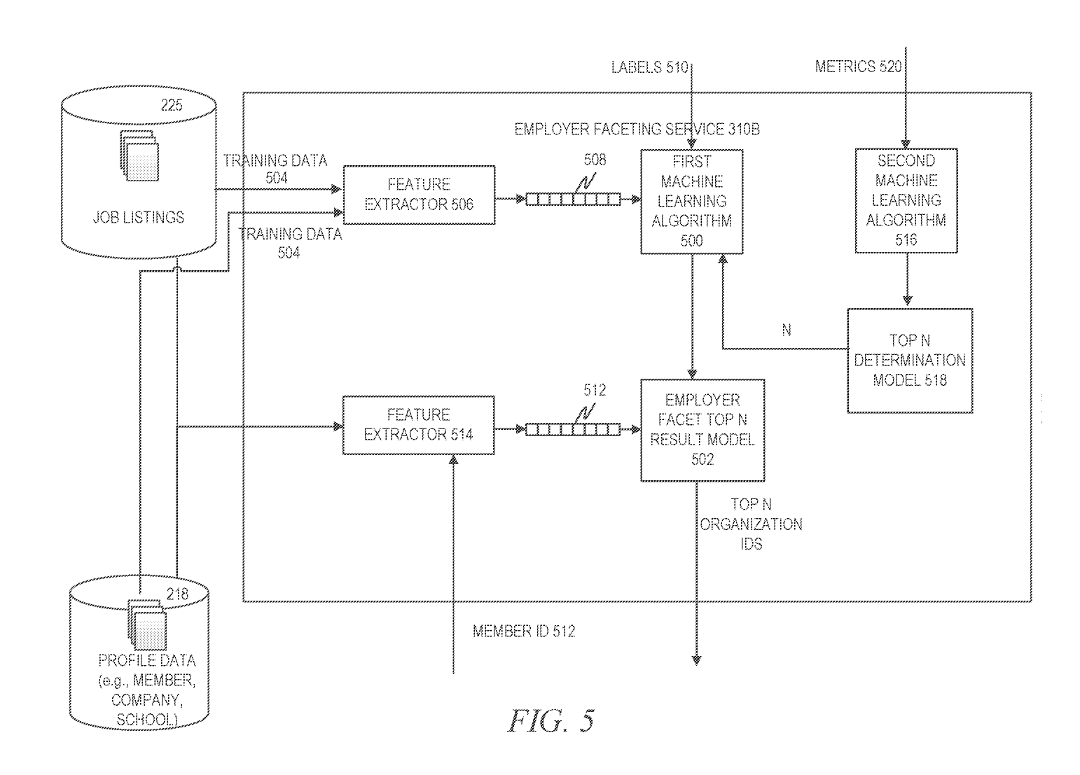

FIG. 5 is a block diagram illustrating an employer faceting service 310B in more detail. Here, a first machine learning algorithm 500 may be used to train an employer facet top N result model 502 to output the top N organizations having employees who previously worked for a particular employer. Specifically, training data 504, in the form of member profiles from profile database 218 and job listing database 224, may be fed to a feature extractor 506, which extracts one or more features 508 from the member profiles. The one or more features 508 may then be fed to the first machine learning algorithm 500 along with one or more labels 510 (in the case of a supervised machine learning algorithm).

The first machine learning algorithm 500 may be selected from among many different potential supervised or unsupervised machine learning algorithms. Examples of supervised learning algorithms include artificial neural networks, Bayesian networks, instance-based learning, support vector machines, random forests, linear classifiers, quadratic classifiers, k-nearest neighbor, decision trees, and hidden Markov models. Examples of unsupervised learning algorithms include expectation-maximization algorithms, vector quantization, and information bottleneck method. In an example embodiment, a binary logistical regression model is used. Binary logistic regression deals with situations in which the observed outcome for a dependent variable can have only two possible types. Logistic regression is used to predict the odds of one case or the other being true based on values of independent variables (predictors).

The one or more features 508 may include, but are not limited to, a count of the number of active job listings from an organization and a count of the number of active employees who previously worked for the employer in question and are currently employed by the organization, the size of the organization, the ratio of the size of the organization and the number of active employees who previously worked for the employer in question currently employed by the organization, etc.

Once the employer facet top N result model 502 is trained, it may be used to produce results of a listing of top N organization IDs when presented with one or more features 512 extracted by a feature extractor 514 from member profiles and/or job listings and when presented with a member ID 512. In this manner, when the search engine API 304 of FIG. 3 sends a member ID, the corresponding members' employers can be retrieved from a corresponding member profile and the top N organization IDs for each employer can then returned to be used to augment the search query.

Additionally, in some other example embodiments, the identification of top N organizations for particular employers may be performed offline and stored for future use, so that the list for various employers may simply be accessed at runtime.

In some example embodiments, N may be a preset number (e.g., 50). In other example embodiments, a second machine learning algorithm 516 may be used to train a top N determination model 518 to determine N. Here, various metrics 520 may be used to train the top N determination model, including how fast the top N organization IDs can be obtained, the relevance of each organization ID (e.g., organizations that have only a few hires from a school may not be relevant, or they might be if the organization is small enough). The metrics 520 may also include the top N organization IDs from the employer facet top N result model 502. It should be noted that in some example embodiments the second machine learning algorithm 516 is the same as the second machine learning algorithm 416 in FIG. 4.

In some example embodiments the employer facet top N result model 502 is used offline, and thus not in response to an actual query coming in, to obtain a list of top N organizations hiring from various employers (e.g., all large companies). This may be performed periodically and the list stored for future access at query-time.

Additionally, in some example embodiments, a threshold test is used prior to obtaining member profiles for members at particular organizations. For example, if the organization currently has no active job posting, then that organization can be excluded from the potential list of top N organizations.

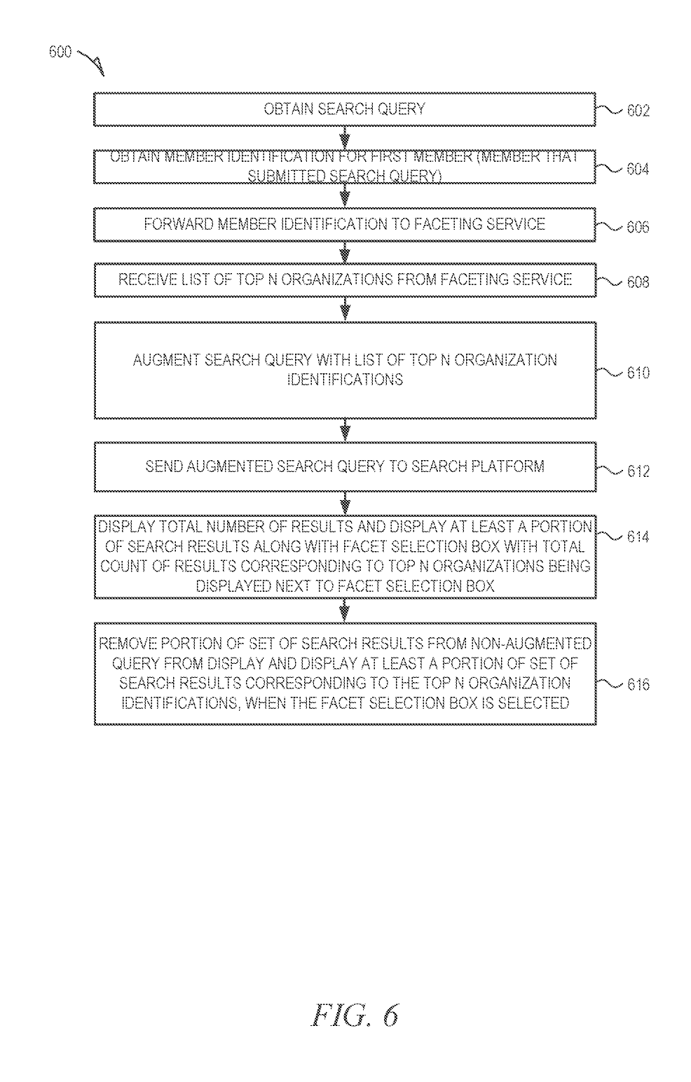

FIG. 6 is a flow diagram illustrating a method 600 for augmenting a search query in a search engine of a computer system in accordance with an example embodiment. At operation 602, a search query is obtained via a user interface. This search query may include, for example, a location and one or more keywords. The location may indicate the desired geographical location of the search results. For example, if the search results are going to be job listings, the location may be the geographical locations of the corresponding jobs. The one or more keywords may be keywords contained in one or more fields of the job listings, such as job title and/or description. The search query may be obtained from a first member of a social networking service, with a corresponding first profile in the social networking service.

At operation 604, a member identification for the first member is obtained. In an example embodiment, this member identification may be transmitted to a search engine API from a search engine front-end as metadata accompanying the search query. The search engine API may, for example, have obtained the member identification by having the first member log in using a user name and/or password and then retrieving a corresponding member identification in response to the sign-in process.

At operation 606, the member identification is forwarded to a faceting service. The faceting service is designed to return a list of top N organization identifications corresponding to organizations having a plurality of employees who share an attribute in common with the first member, as described earlier.

At operation 608, the list of top N organization identifications is received from the faceting service. At operation 610, the search query is augmented with the list of top N organization identifications. At operation 612, the augmented search query to the search platform to obtain a set of search results corresponding to the top N organization identifications. At operation 614, the total number of results may be displayed. In an example embodiment, the total number of results are displayed at the top of the display. Additionally, as part of operation 614, at least a portion of the search results may be displayed along with a facet selection box, with the total count of results corresponding to the top n organizations being displayed next to (e.g., to the right of) the facet selection box. At operation 616, when the facet selection box is selected the at least a portion of the set of search results from the non-augmented query is removed from display and at least a portion of the set of search results corresponding to the top N organization identifications is displayed.

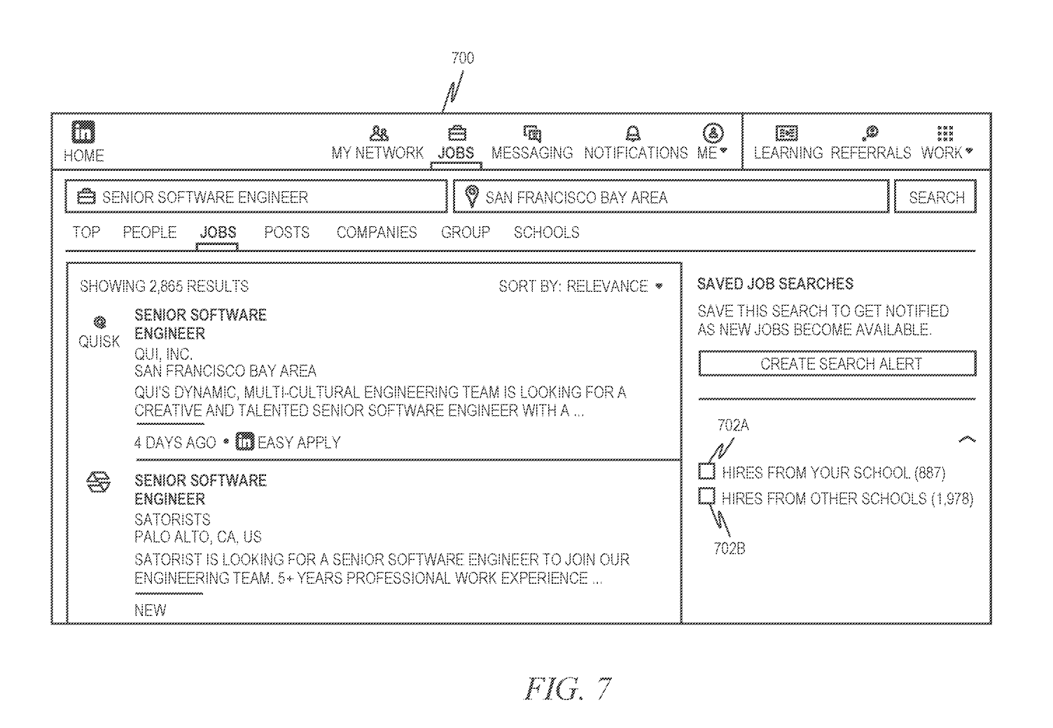

FIG. 7 is a screen capture 700 depicting job flavor faceting of job search results in accordance with an example embodiment. Here, facets 702A, 702B are provided relating to the searcher's school. Specifically, facet 702A allows the searcher to filter search results based on employers who have hired from the searcher's school.

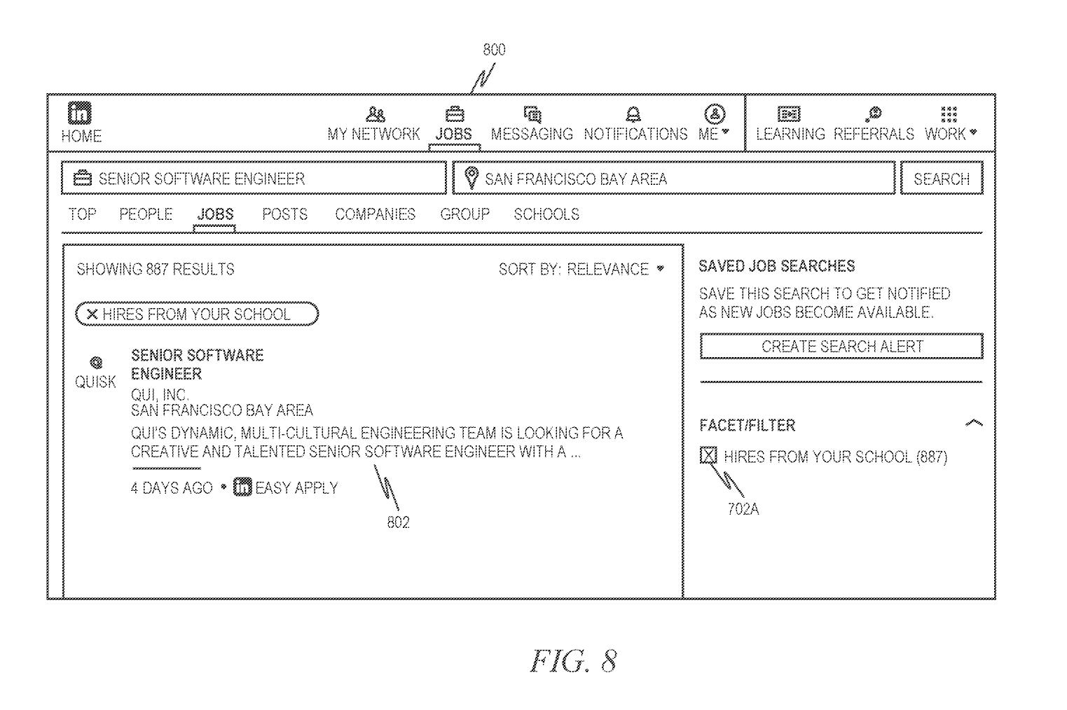

FIG. 8 is a screen capture 800 depicting filtered job search results in accordance with an example embodiment. Here, facet 702A has been selected by the searcher, which causes only job search results 802 matching the selected criteria to be displayed.

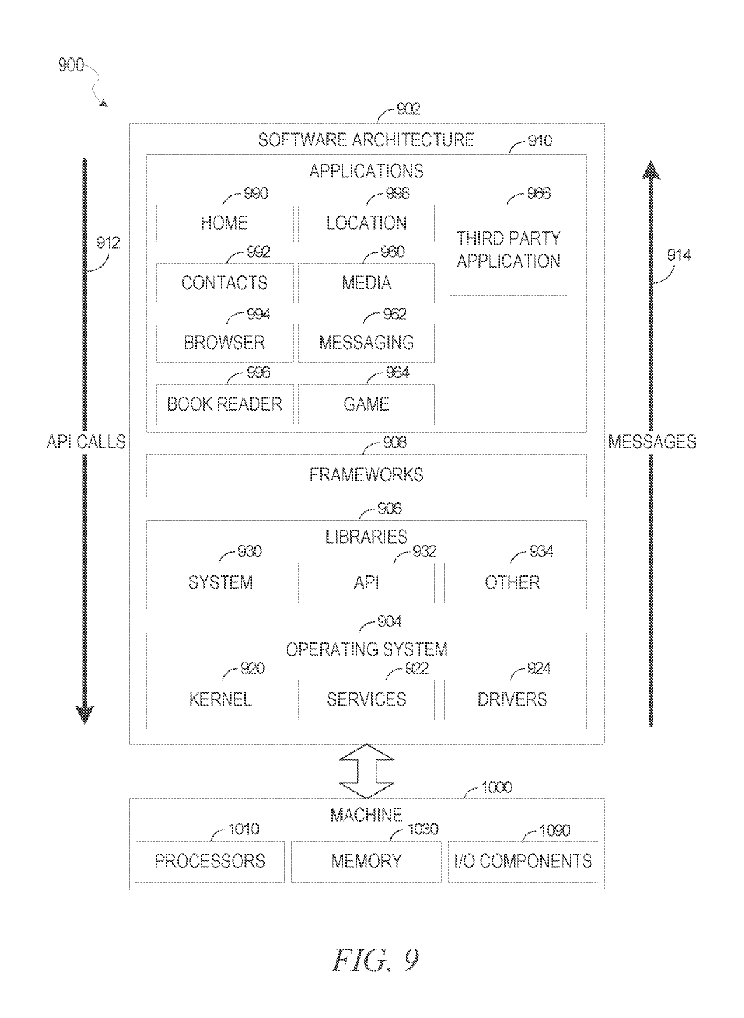

FIG. 9 is a block diagram 900 illustrating an architecture of software 902, which can be installed on any one or more of the devices described above. FIG. 9 is merely a non-limiting example of a software architecture, and it will be appreciated that many other architectures can be implemented to facilitate the functionality described herein. In various embodiments, the software 902 is implemented by hardware such as a machine 600 of FIG. 6 that includes processors 610, memory 630, and I/O components 650. In this example architecture, the software 902 can be conceptualized as a stack of layers where each layer may provide a particular functionality. For example, the software 902 includes layers such as an operating system 904, libraries 906, frameworks 908, and applications 910. Operationally, the applications 910 invoke application programming interface (API) calls 912 through the software stack and receive messages 914 in response to the API calls 912, consistent with some embodiments.

In various implementations, the operating system 904 manages hardware resources and provides common services. The operating system 904 includes, for example, a kernel 920, services 922, and drivers 924. The kernel 920 acts as an abstraction layer between the hardware and the other software layers, consistent with some embodiments. For example, the kernel 920 provides memory management, processor management (e.g., scheduling), component management, networking, and security settings, among other functionality. The services 922 can provide other common services for the other software layers. The drivers 924 are responsible for controlling or interfacing with the underlying hardware, according to some embodiments. For instance, the drivers 924 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 906 provide a low-level common infrastructure utilized by the applications 910. The libraries 906 can include system libraries 930 (e.g., C standard library) that can provide functions such as memory allocation functions, string manipulation functions, mathematic functions, and the like. In addition, the libraries 906 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 906 can also include a wide variety of other libraries 934 to provide many other APIs to the applications 910.

The frameworks 908 provide a high-level common infrastructure that can be utilized by the applications 910, according to some embodiments. For example, the frameworks 908 provide various graphic user interface (GUI) functions, high-level resource management, high-level location services, and so forth. The frameworks 908 can provide a broad spectrum of other APIs that can be utilized by the applications 910, some of which may be specific to a particular operating system or platform.

In an example embodiment, the applications 910 include a home application 950, a contacts application 952, a browser application 954, a book reader application 956, a location application 958, a media application 960, a messaging application 962, a game application 964, and a broad assortment of other applications such as a third-party application 966. According to some embodiments, the applications 910 are programs that execute functions defined in the programs. Various programming languages can be employed to create one or more of the applications 910, structured in a variety of manner such as object-oriented programming languages (e.g., Objective-C, Java, or C++) or procedural programming languages (e.g., C or assembly language). In a specific example, the third-party application 966 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 966 can invoke the API calls 912 provided by the operating system 904 to facilitate functionality described herein.

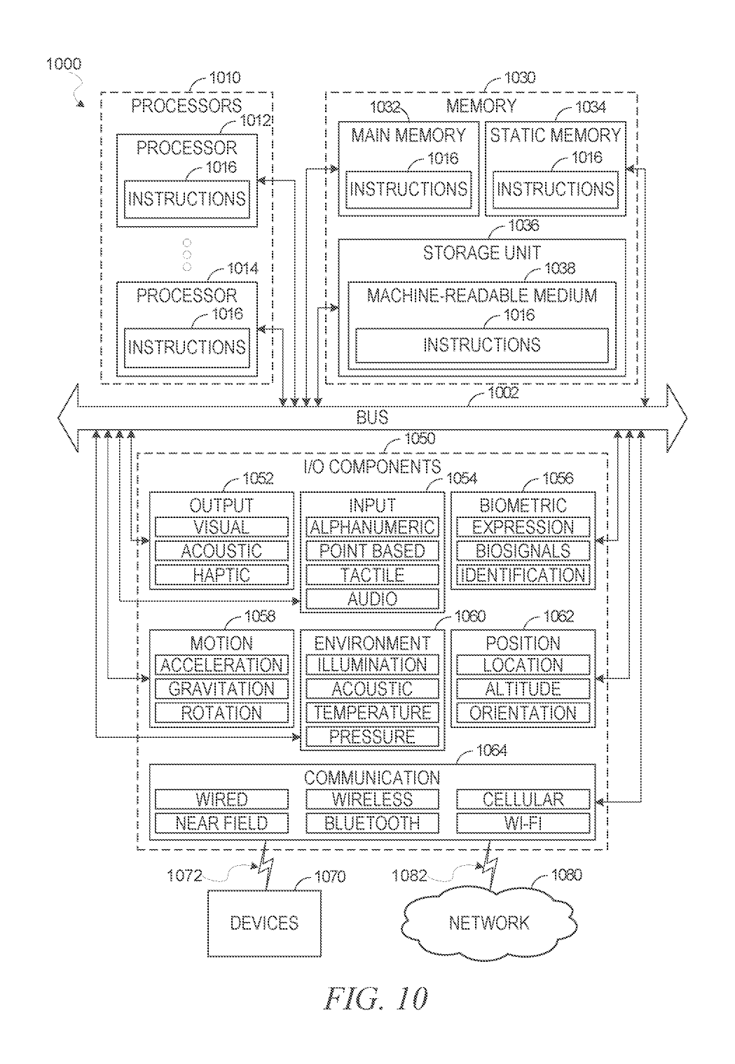

FIG. 10 illustrates a diagrammatic representation of a machine 1000 in the form of a computer system within which a set of instructions may be executed for causing the machine to perform any one or more of the methodologies discussed herein, according to an example embodiment Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example the instructions 1016 may cause the machine 1000 to execute the method 400 of FIG. 4. Additionally, or alternatively, the instructions 1016 may implement FIGS. 1-4, and so forth. The instructions 1016 transform the general, non-programmed machine 1000 into a particular machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory 1030, and I/O components 1050, which may be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1012 and a processor 1014 that may execute the instructions 1016. The term “processor” is intended to include multi-core processors that may comprise two or more independent processors (sometimes referred to as “cores”) that may execute instructions contemporaneously. Although FIG. 10 shows multiple processors 1010, the machine 1000 may include a single processor with a single core, a single processor with multiple cores (e.g., a multi-core processor), multiple processors with a single core, multiple processors with multiples cores, or any combination thereof.

The memory 1030 may include a main memory 1032, a static memory 1034, and a storage unit 1036, both accessible to the processors 1010 such as via the bus 1002. The main memory 1030, the static memory 1034, and storage unit 1036 store the instructions 1016 embodying any one or more of the methodologies or functions described herein. The instructions 1016 may also reside, completely or partially, within the main memory 1032, within the static memory 1034, within the storage unit 1036, within at least one of the processors 1010 (e.g., within the processor's cache memory), or any suitable combination thereof, during execution thereof by the machine 1000.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062, among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1062 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a USB).

Moreover, the communication components 1064 may detect identifiers or include components operable to detect identifiers. For example, the communication components 1064 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 1030, 1032, 1034, and/or memory of the processor(s) 1010) and/or storage unit 1036 may store one or more sets of instructions and data structures (e.g., software) embodying or utilized by any one or more of the methodologies or functions described herein. These instructions (e.g., the instructions 1016), when executed by processor(s) 1010, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 1080 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., hypertext transfer protocol (HTTP)). Similarly, the instructions 1016 may be transmitted or received using a transmission medium via the coupling 1072 (e.g., a peer-to-peer coupling) to the devices 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1016 for execution by the machine 1000, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
a computer-readable medium having instructions stored thereon, which, when executed by a processor, cause the system to:
receive, via a user interface, a search query;
obtain a member identification, in a social networking service, for a member who generated the search query;
forward the member identification to a faceting service, the faceting service designed to return a list of top N organization identifications corresponding to organizations having a plurality of employees who share an attribute in common with the member;
receive the list of top N organization identifications from the faceting service;
augment the search query with the list of top N organization identifications;
send the augmented search query to a search platform to obtain a first set of search results corresponding to the top N organization identifications; and
cause the display, in the user interface, at least a portion of the first set of search results.

2. The system of claim 1, wherein the instructions further cause the system to:
send the search query in non-augmented form to the search platform to obtain a second set of search results;
display, in the user interface, at least a portion of the second set of search results along with a facet selection box corresponding to the attribute, the facet selection box, when selected, causing removal of the at least a portion of the second set of search results from display and the display of the at least a portion of the first set of search results.

3. The system of claim 1, wherein the attribute is a school attended by the member.

4. The system of claim 1, wherein the attribute is an employer of the member.

5. The system of claim 1, wherein the faceting service includes a faceting model trained by a first machine learning algorithm to output a list of top N organization identifications in response to a member ID, the first machine learning algorithm using a value for N and having been trained by feeding training data from member profiles and other content to a feature extractor, which extracts one or more features from the member profiles and the other content, and sending the one or more features to the first machine learning algorithm, the one or more features including a count of a number of content items from organizations with employees having the attribute and sizes of the organizations.

6. The system of claim 5, wherein N is a preset value.

7. The system of claim 5, wherein N is a variable value calculated by a top N determination model trained by a second machine learning algorithm using one or more metrics.

8. A computerized method comprising:
receiving, via a user interface, a search query;
obtaining a member identification, in a social networking service, for a member who generated the search query;
forwarding the member identification to a faceting service, the faceting service designed to return a list of top N organization identifications corresponding to organizations having a plurality of employees who share an attribute in common with the member;
receiving the list of top N organization identifications from the faceting service;
augmenting the search query with the list of top N organization identifications;
sending the augmented search query to a search platform to obtain a first set of search results corresponding to the top N organization identifications; and
causing the display, in the user interface, at least a portion of the first set of search results.

9. The computerized method of claim 8, further comprising:
sending the search query in non-augmented form to the search platform to obtain a second set of search results;
displaying, in the user interface, at least a portion of the second set of search results along with a facet selection box corresponding to the attribute, the facet selection box, when selected, causing removal of the at least a portion of the second set of search results from display and the display of the at least a portion of the first set of search results.

10. The computerized method of claim 9, wherein the attribute is a school attended by the member.

11. The computerized method of claim 9, wherein the attribute is an employer of the member.

12. The computerized method of claim 9, wherein the faceting service includes a faceting model trained by a first machine learning algorithm to output a list of top N organization identifications in response to a member ID, the first machine learning algorithm using a value for N and having been trained by feeding training data from member profiles and other content to a feature extractor, which extracts one or more features from the member profiles and the other content, and sending the one or more features to the first machine learning algorithm, the one or more features including a count of a number of content items from organizations with employees having the attribute and sizes of the organizations.

13. The computerized method of claim 12, wherein N is a preset value.

14. The computerized method of claim 12, wherein N is a variable value calculated by a top N determination model trained by a second machine learning algorithm using one or more metrics.

15. A non-transitory machine-readable storage medium having instruction data to cause a machine to perform the following operations:
receiving, via a user interface, a search query;
obtaining a member identification, in a social networking service, for a member who generated the search query;
forwarding the member identification to a faceting service, the faceting service designed to return a list of top N organization identifications corresponding to organizations having a plurality of employees who share an attribute in common with the member;
receiving the list of top N organization identifications from the faceting service;
augmenting the search query with the list of top N organization identifications;
sending the augmented search query to a search platform to obtain a first set of search results corresponding to the top N organization identifications; and
causing the display, in the user interface, at least a portion of the first set of search results.

16. The non-transitory machine-readable storage medium of claim 15, further comprising:
sending the search query in non-augmented form to the search platform to obtain a second set of search results;
displaying, in the user interface, at least a portion of the second set of search results along with a facet selection box corresponding to the attribute, the facet selection box, when selected, causing removal of the at least a portion of the second set of search results from display and the display of the at least a portion of the first set of search results.

17. The non-transitory machine-readable storage medium of claim 15, wherein the attribute is a school attended by the member.

18. The non-transitory machine-readable storage medium of claim 15, wherein the attribute is an employer of the member.

19. The non-transitory machine-readable storage medium of claim 15, wherein the faceting service includes a faceting model trained by a first machine learning algorithm to output a list of top N organization identifications in response to a member ID, the first machine learning algorithm using a value for N and having been trained by feeding training data from member profiles and other content to a feature extractor, which extracts one or more features from the member profiles and the other content, and sending the one or more features to the first machine learning algorithm, the one or more features including a count of a number of content items from organizations with employees having the attribute and sizes of the organizations.

20. The non-transitory machine-readable storage medium of claim 19, wherein N is a variable value calculated by a top N determination model trained by a second machine learning algorithm using one or more metrics.
